(19) United States
(12) Patent Application Publication
(10) Pub. No.: US 2017/0324684 A1
(43) Pub. Date: Nov. 9, 2017

(54) CENTRALIZED MESSAGE SYSTEM AND METHODS

(71) Applicants: Bidhu Kishan Dharmapalan, Alpharetta, GA (US); Ajith V. Prabhakar, Monmouth Junction, NJ (US)

(72) Inventors: Bidhu Kishan Dharmapalan, Alpharetta, GA (US); Ajith V. Prabhakar, Monmouth Junction, NJ (US)

(21) Appl. No.: 15/591,058

(22) Filed: May 9, 2017

Related U.S. Application Data
(60) Provisional application No. 62/333,491, filed on May 9, 2016.

(51) Int. Cl. H04L 12/58; G06Q 30/00; G06K 7/14; G06Q 10/10

(52) U.S. Cl. CPC H04L 51/04; H04L 51/24; H04L 51/18; G06K 7/1417; G06Q 10/107; G06Q 30/016

(57) ABSTRACT

A centralized message system includes a controller in communication with one or more vendor user interfaces for each vendor and one or more consumer user interfaces for each consumer and a database including a plurality of consumers and a plurality of vendors, wherein each consumer has an associated vendor list, wherein each vendor has an associated consumer list. The centralized message system also includes a memory coupled to the controller configured to store program instructions executable by the controller, that, when executed, cause the controller to receive a request from a first vendor to add a first consumer to a consumer list of the first vendor and to receive a request from a second consumer to add a second vendor to a vendor list of the second consumer.

### CROSS-REFERENCE TO RELATED APPLICATIONS

This application incorporates by reference and claims priority to U.S. Provisional Application Patent No. 62/333,491 filed May 9, 2016.

### BACKGROUND OF THE INVENTION

The present subject matter relates generally to a centralized message system. More specifically, the present invention relates to a centralized computerized message system capable of propagating customized sets of messages from a plurality of vendors to a plurality of consumers.

Modern smartphones and other mobile devices were derived, at least in part, from personal digital assistants (PDAs) and other rudimentary smart mobile devices. These older devices gained popularity because of their ability to multitask, including functionality with which users could digitally manage and track their schedules and also be provided with reminders of upcoming events. This functionality, along with every other useful function of a PDA, has now been integrated into modern smartphones, tablets, and even smart watches. These devices provide their users with the ability to not only digitally manage their schedules, but can also be linked to other devices via cloud based computing allowing for a single, unified schedule to be displayed to a user no matter what device they are accessing it from.

The ability to seamlessly manage a user's schedule or schedules across all devices, is extremely useful both for business and personal uses. Accounting for the schedules of multiple family members is exceedingly complicated, even with the advent of computerized scheduling. To help ease the burden, technological innovations have arisen which allow for online scheduling of almost all forms of appointments, such as check-ups with a doctor, car maintenance, workout classes, etc. Combined with the ability to send out virtual messages and messages via email mailing lists and/or mass text messages, this online scheduling greatly improves the ability of busy families to keep track of their schedules.

However, the present solutions for keeping track of important appointments, scheduling update messages, and other messages are not without their shortcomings. Many online appointment scheduling systems are not integrated with one another and often require the download or use of a proprietary application or website. As a user, this may be frustrating due to the need to maintain multiple storage-space consuming and battery consuming applications on his mobile device to account for his various scheduling needs. Additionally, all of these scheduling applications and websites may send different types of notifications to a user, creating a potentially confusing array of messages and messages without a common theme, formatting, or the ability to control all notification settings at once.

Current scheduling technologies also include sending updates or alerts via text message, mass email, or automated phone call. Each of these manners of communication has its own shortcomings. Due to the propensity for spam email, inadvertent typos in email addresses, hoax and spoofed emails, and a large number of emails for the user to sort through, users may be less inclined to use their email for another service. Email alerts also require the user to open the email and increase the potential for malicious attacks on home computers. Another alternative is providing an alert through a text message, but such messages cannot be prioritized or filtered. Some vendors currently offer applications through which to send push notifications, but each individual vendor application must be installed on the user's mobile device. Messages such as email, text, and individual vendor application push notifications are more difficult for a computerized scheduling system to account for because the format in which they are sent may not lend itself to being integrated with existing scheduling applications. Typically, these automated messages are one-way communications without the ability to reschedule or cancel appointments directly from the message received.

Accordingly, there is a need for a centralized computerized message system capable of propagating customized sets of messages for a plurality of users.

### BRIEF SUMMARY OF THE INVENTION

To meet the needs described above and others, the present disclosure provides a centralized computerized message system capable of propagating customized sets of messages or alerts from a vendor to a plurality of consumers. The centralized message system includes a single platform through which a consumer may receive messages from a plurality of vendors, and through which a single vendor may reach a targeted set of consumers. The messages may include reminders, push notifications, and/or confirmation messages from service providers such as pharmacies, car dealerships, pet care providers, banks, and the like. In some embodiments, the message may include options of how to respond to the messages such as adding a calendar event, confirming an appointment, calling the vendor, signing up for a service or event, or taking some action required by the vendor in order to continue using the vendor's services.

One embodiment of the invention may consist of a computerized system featuring mobile applications, web server, internet-based administration website, and an application programming interface (API) accessed by the vendors and consumers. The mobile application may be run on any device capable of running a computer application including, but not limited to, smartphones, tablets, laptops, netbooks, wearable devices and other mobile computing devices. The mobile application may feature a graphical user interface (GUI), voice prompt, hologram, virtual reality display, or other interface which will display alerts from various alert providers. The messages displayed on the mobile application's GUI are shown in the form of a list, displayed to consumers based off pre-defined settings previously established by the consumers. This centralized message system allows consumers to identify what types of messages they want to receive (e.g., local school updates, doctor's appointment changes, etc.), to assign a priority level to each type of alert, and to define which alerts fall into which category. The alert priority levels may also be determined by the vendors. These pre-defined priority levels indicate to the centralized message system the order in which various alerts received by a user should be displayed on the mobile application (e.g., highest priority to be displayed first) and can also be used by the mobile application as an indication that some other action on the mobile application should be taken (e.g., a high alert notification makes the device vibrate as an additional alert, while a lower priority alerts only display on the mobile app GUI). In some embodiments, users can subscribe to or modify the category of an alert from their mobile application as well as from a website.

A centralized server acts as the main hub for message notifications sent and received by the centralized message system. The server may utilize the internet or any other acceptable means of networking the system components together (e.g., Bluetooth, RF, ZigBee, etc.). The server stores a unique profile for each mobile application consumer in which the alert settings defined by these users on the administration website are stored. As mentioned previously, vendors may use the centralized message system to send messages and scheduling updates to users. When such a message is sent, for example, by a school administrator when a school is closed on a snow day, the centralized server receives message instructions from the vendor and then transmits the message to all users who have opted to receive such a message or all users identified in the message instructions. The messages sent to each consumer by the server also have the priority level, pre-defined by the consumer, by the vendor, or assigned to them by the server. In some embodiments, the server determines and assigns the priority of the message based on the context of message using artificial intelligence or machine learning algorithms.

This embodiment is not limited to one-way messaging, as the messages and notifications may include options by which the consumers can update appointment scheduling systems and send another form of a response message. For instance, if a doctor is sick and needs to cancel all appointments for that day, he may utilize the centralized message system to send an alert to all subscribed users that the office is closed. Additionally, the vendor may opt to send a notification which allows consumers to reschedule the canceled event or appointment. If a patient receives the “office closed” alert via the centralized message system, he may simply need to respond to the message to reschedule their appointment. This rescheduled appointment can then automatically have a reminder message sent for the new date and time of the appointment by the system, as well as update the patient's schedule via integration with one or more scheduling applications.

The messages can also function as reminders for routine events as impacted by outside variables. For example, a consumer may set up a message to catch the train or bus at a specific time each night. The consumer may opt to receive messages about the status of their transit choice, such as if the train or bus is running on time, if it is broken down, etc. The centralized message system may also take into account factors such as the weather, traffic conditions, and any other events that impact commute time and scheduling, and then relay this information to the user. If a major snowstorm had occurred earlier in the day, the centralized message system may send a message recommending that the consumer should leave work earlier than normal to account for a slower walk the train terminal or bus stop, or that the consumer should take an earlier train or bus if a later transit option is likely to be canceled.

The system's capability extends beyond transit messages and can be applied to any situation in which alerts would be helpful to system users. Another example could be that of a financial crash. The economy fluctuates regularly and many times it is helpful to react quickly and move investments to avoid financial loss. The present invention may be set up to alert users of when stocks on the stock exchange drop in value and also account for multiple pieces of financial data to alert consumers to, for instance, sell their stock in a tech company, and buy oil stock instead to protect their monetary investment.

An objective of the present invention is to provide a single platform from which various forms of messages from various vendors may be sent out to relevant consumers. Efficiency is optimized by eliminating the need for multiple individual vendor applications. The centralized message system allows for scheduling changes, community alerts, weather updates, and other notifications to all be processed by one unified system. The messages may have a standardized alert format to simplify the consumers' interactions with messages from various vendors. Additionally, the present system provides the consumers with the ability to carry out appropriate actions (e.g., adding an event to a user's calendar, confirming or rescheduling an appointment, or calling the provider) needed upon receipt of such messages.

An advantage of the present invention is that the unified, single platform for messages will help consumers view messages quickly instead of checking multiple locations for such messages. Currently, a consumer would typically have to review her email inbox, her text messages, her voice mail, and several mobile applications to ensure all her daily appointments and events are up-to-date.

Another advantage of the present invention is that this application will eliminate clutter of irrelevant messages and alerts, helping consumers focus only on the messages that need to be acted upon or made note of. Some example vendors include service providers such as pharmacies, car dealerships, physicians, schools, banks, laundries, department stores, hospitals, laboratories, airlines, restaurants, pet care providers, day care facilities, high educational institutes, etc. If a consumer were to sign up for various messages and notifications from all the sources listed above individually, the amount of excess information a user would receive in the form of advertisements and other irrelevant information would be overwhelming and impractical to manage. The system of the present application eliminates any “junk” messages from service providers and provides only updates which may impact a person's schedule.

Yet another advantage of the present invention is that the alerts provided to a consumer are customizable. In some embodiments, vendors and consumers can assign messages from specific a level of importance, such as high, medium, low, or any other designation useful to system users. This platform will also check for read receipts and will provide multiple notifications to the consumer in case the consumer has not viewed a high priority message. Each level will not only dictate how the alerts are presented to a user of the system's mobile application (e.g., highest priority on top) but can also be used to trigger additional notifications on a user device (e.g., high alerts sound an audio tone or cause the device to vibrate). This allows the system to be used not only to update scheduling of day-to-day routine errands but is also a reliable alert mechanism during emergency situations.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations described below.

### BRIEF DESCRIPTION OF THE DRAWINGS

The drawing figures depict one or more implementations in accord with the present concepts, by way of example only, not by way of limitations.

FIG. 1 is a schematic of the centralized message system of the present application.

FIG. 2 is a schematic representation of the various functions that may be provided by the centralized message system of FIG. 1.

FIG. 3 is a flowchart illustrating an example method of vendors and consumers communicating through the centralized message system of FIG. 1.

FIG. 4 is a flowchart illustrating an example method of determining when send a transportation alert message to a consumer through the centralized message system of FIG. 1.

FIG. 5 is a message dashboard user interface of the centralized message system of FIG. 1.

FIG. 6 is a consumer request user interface of the centralized message system of FIG. 1.

FIG. 7 is a consumer information share user interface of the centralized message system of FIG. 1.

### DETAILED DESCRIPTION OF THE INVENTION

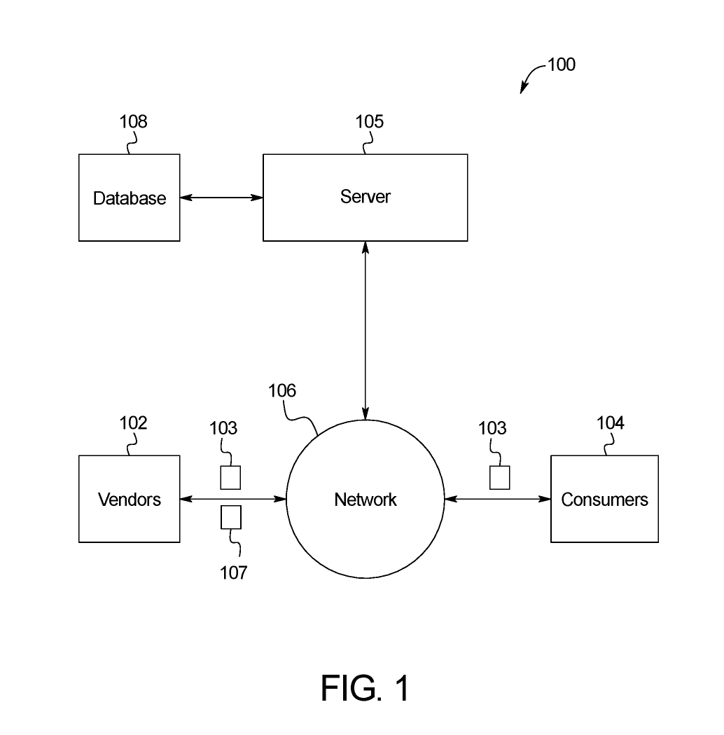

FIG. 1 illustrates an example of a centralized message system 100 of the present application. As shown in FIG. 1, one or more vendors 102 and one or more consumers 104 may interact with the centralized message system server 105 through a network 106. Through the network 106, the communication message system 100 provides a mobile application and/or an interactive website through which the vendors 102 and the consumers 104 may share information and send messages 103. More specifically, a vendor 102 may submit message instructions 107 to the server 105 to request that a message 103 be sent to one or more consumers 104. As is described in further detail below, the communication message system 100 improves the efficiency with which vendors 102 communicate with current and potential consumers 104. Vendors 102 may include any business such as schools, car dealerships, doctor's offices, pharmacies, local banks, national banks, investment firms, or financial news sources.

Referring to FIG. 1, the server 105 may be in communication with a database 108. The database 108 includes a listing of a plurality of vendors 102 and a plurality of consumers 104 participating in the centralized message system 100. Each vendor 102 has an associated consumer list. Each vendor 102 may create one or more subsets of consumers 104 within the consumer list according to aspects such as class times, age groups, user account type, or any suitable common factor as determined by the vendor. Similarly, each consumer 104 has an associated vendor list and may include one or more subsets of vendors grouped as desired by the consumer 104. For example, a consumer 104 may create a subset of vendors associated with a family member, work, extra-curricular, or any such factor. While shown and described as a database 108, it is understood that the database 108 may be any number of databases adapted to support the necessary data management to support the various features and functions of the centralized message system 100 described herein. It is further contemplated that the database 108, as understood in the traditional sense, may not be a requirement of the centralized message system 100, and that any other mechanism or mode of data management may be employed.

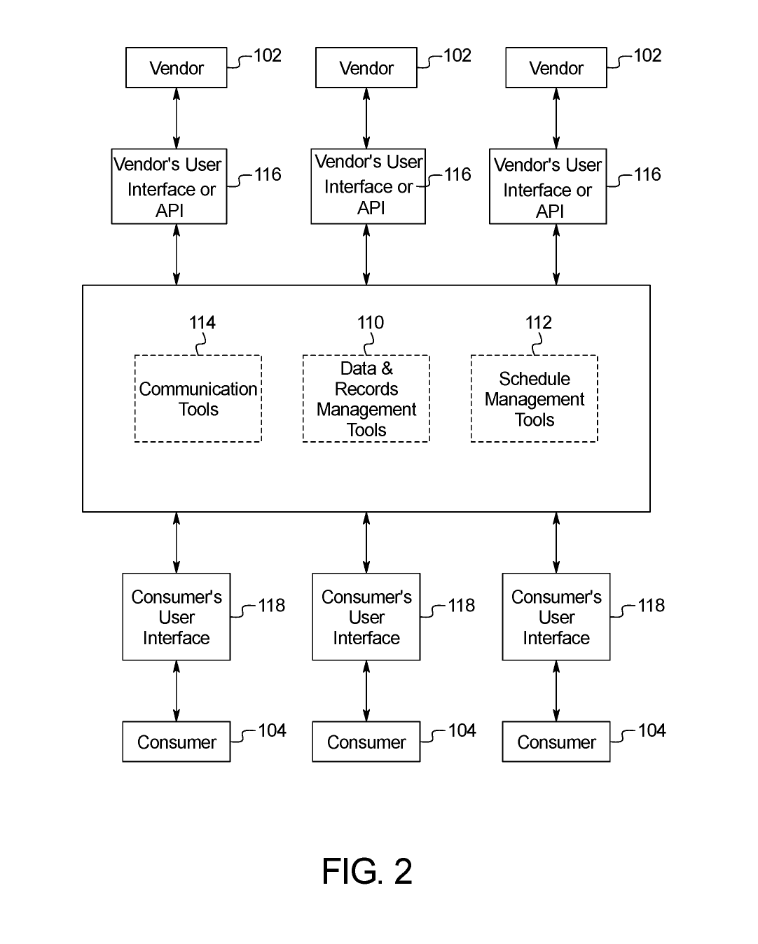

FIG. 2 illustrates the various functions that may be provided by the centralized message system 100. For example, the centralized message system 100 may provide data and records management tools 110, scheduling management tools 112, and communication tools 114. While the embodiment of the centralized message system 100 shown in FIG. 2 is presently the preferred embodiment, it is contemplated that various versions of the centralized message system 100 may include a greater or lesser number of management tools 110, 112, 114 and will be apparent to those skilled in the art based on the disclosure provided herein. It is further understood that while the various tools are expressed as independent elements within the example of the centralized message system 100 shown in FIG. 2, such separation is provided for simplification and clarity of the description and it is known that the various tools may be overlapping, fully integrated, or otherwise interrelated, as will be understood by those skilled in the art.

In the example provided in FIG. 2, a plurality of vendors 102 is shown accessing a centralized message system 100 through each respective vendor user interface 116 or application programming interface (API). The vendor user interface 116 may be provided through a mobile application resident on a smartphone or similar mobile handheld computing device or through a website accessible through the internet. Each consumer 104 accesses the centralized message system 100 through a consumer user interface 118 provided in mobile applications, through one or more websites, or in any other networked application or communication protocol.

The data and records management tool 110 of the centralized message system 100 may allow the vendor 102 to collect, organize, and analyze data generated in the course of their business. The centralized message system 100 allows the vendors 102 to communicate with any subset of consumers 104 on the vendor's consumer list through messages 103. Consumers 104 receive and respond to messages 103 as necessary. The centralized message system 100 allows vendors 102 and consumers 104 to optimize their schedules using various schedule management tools 112 such as calendars and notification systems via the messages 103. Collecting and organizing the data generated in this manner may help vendors 102 and consumers 104 communicate efficiently.

The centralized message system 100 may also facilitate communication between vendors 102 and consumers 104 through various communication tools 114 by providing a centralized platform to inform consumers 104 of changes in schedules, requests for information, and updates to vendor information.

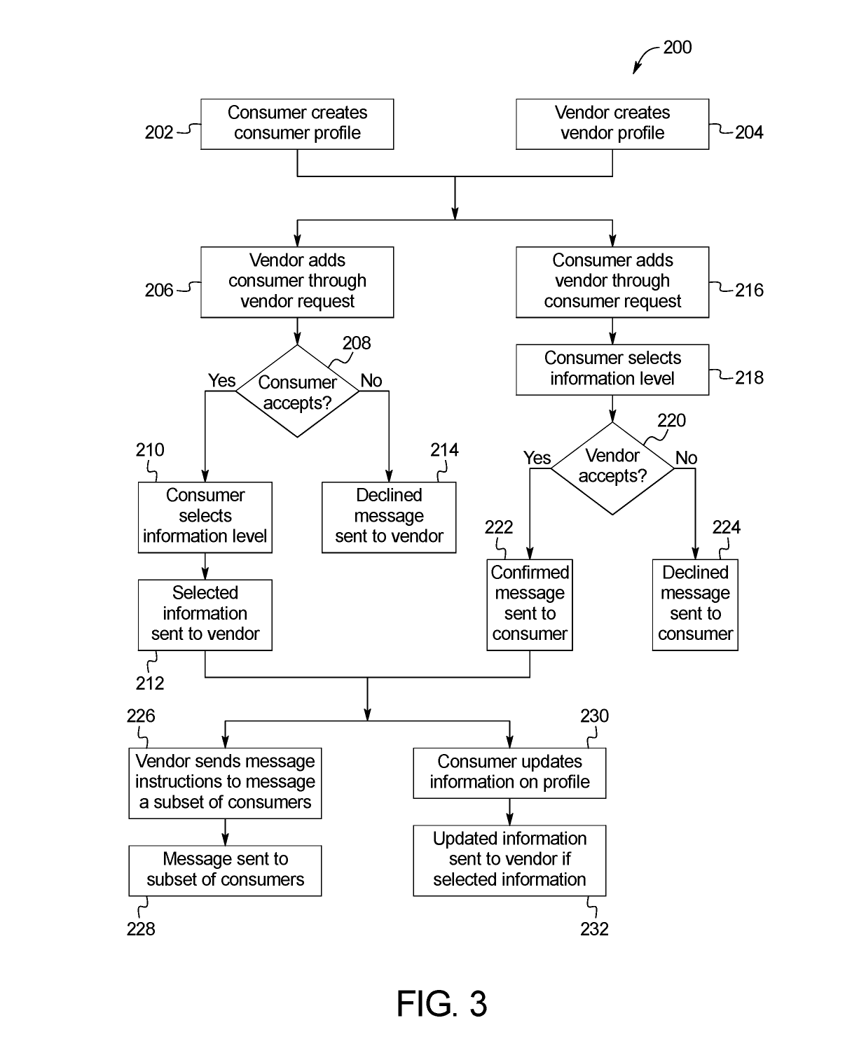

FIG. 3 expands on the concepts described with respect to FIGS. 1 and 2 by providing additional detailed examples. It is understood that the centralized message system 100 may be implemented to provide a wealth of tools and management services and that these examples are not limitations on the numerous uses of the centralized message system.

FIG. 3 illustrates an example method 200 of vendors 102 and consumers 104 providing information to and connecting through the centralized message system 100. In the first step 202, each consumer 104 creates a consumer profile on the centralized message system 100 through the consumer user interface 118. The consumer 104 provides information such as his name, address, phone number, email address, and other identifying information as the consumer 104 creates the consumer profile. The centralized message system 100 generates a consumer identifier for each consumer. In step 204, each vendor 102 creates a vendor profile on the centralized message system 100 through vendor user interface 116, wherein the vendor 102 provides vendor information to create the vendor profile and defines a consumer data requirement set. The centralized message system 100 generates an identification code and a QR code for each vendor.

Consumers 104 can be added to a vendor's consumer list through either a vendor's request described in steps 206-214 or a consumer's request described in steps 216-224. In step 206, a vendor 102 sends a vendor request through the vendor user interface 116 to add a consumer 104 to the vendor's consumer list. The vendor 102 may send a request to the consumer 104 by email, SMS message, or other method through the centralized message system 100. The consumer 104 receives a notification through its consumer user interface 118, asking the consumer 104 to either accept or reject the vendor's request. In step 208, the consumer 104 decides whether to accept the vendor's request.

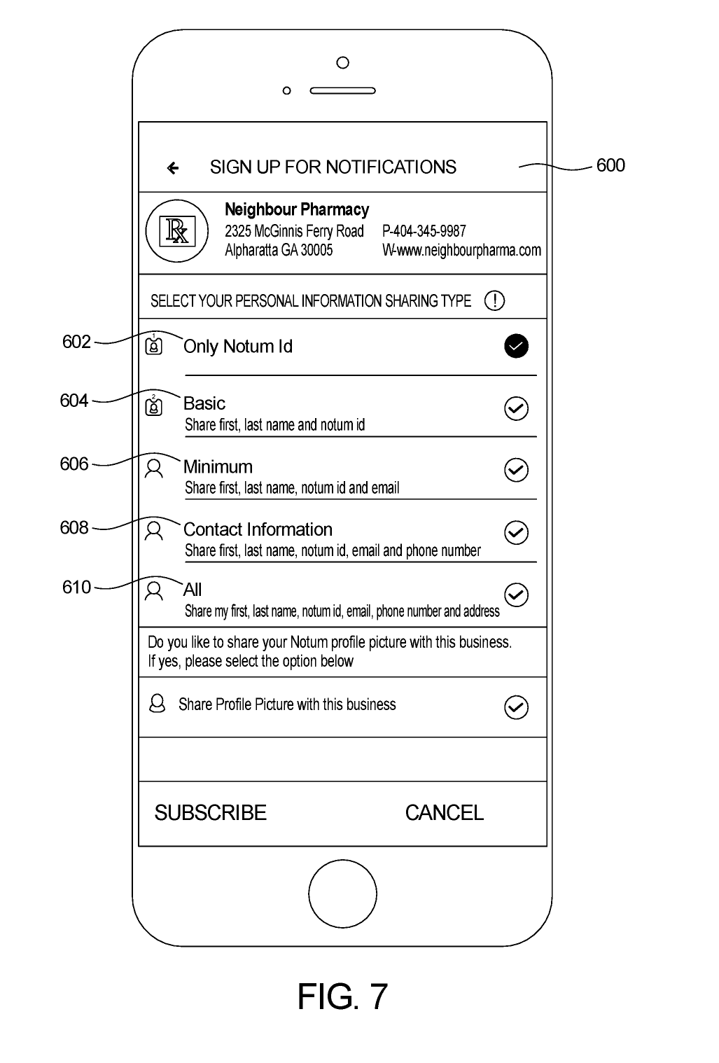

If the consumer 104 accepts in step 208, the consumer 104 then selects which category or level of information to provide to the vendor in step 210. In the embodiment illustrated in FIG. 7, a consumer information share user interface 600 of the centralized message system includes a number of categories or levels of information that the consumer 104 can choose to share with a particular vendor 102. The first category or level 602 of information includes only the consumer identifier. In the second category 604, selection of the second category shares basic information such as name and consumer identifier. The third level 606 of information may include name, consumer identifier, and email address, while the fourth level 608 also includes the phone number. The final category 610 includes name, the consumer identifier, email address, home number, and residential address. Other levels of information may include access to calendar information or credit card information. The centralized message system 100 may also provide any number of categories or levels of information specific to vendors 102 so that a consumer 104 may store information that can be collected and identified as it relates to specific categories such as medical records, employment information, personal information needed to complete a lease or application for financing a car, personal information needed to complete an application for an apartment. The consumer 104 may choose to share categories or levels of information with a specific vendor 102 at any given time. For example, a consumer 104 may store employment information on the server 105 of the centralized message system 100 to share with a recruiting company vendor 102 as well as a potential employer vendor 102.

Consumer information may be encrypted in order to protect consumer and vendor information and systems. In some embodiments, the consumer 104 may select a time duration for how long the selected information is shared with a specific vendor 102. Returning to the method 200 in FIG. 3, if the consumer 104 declined the vendor's request at step 208, then a declined message is sent to the vendor 102 through the centralized message system 100 in step 214.

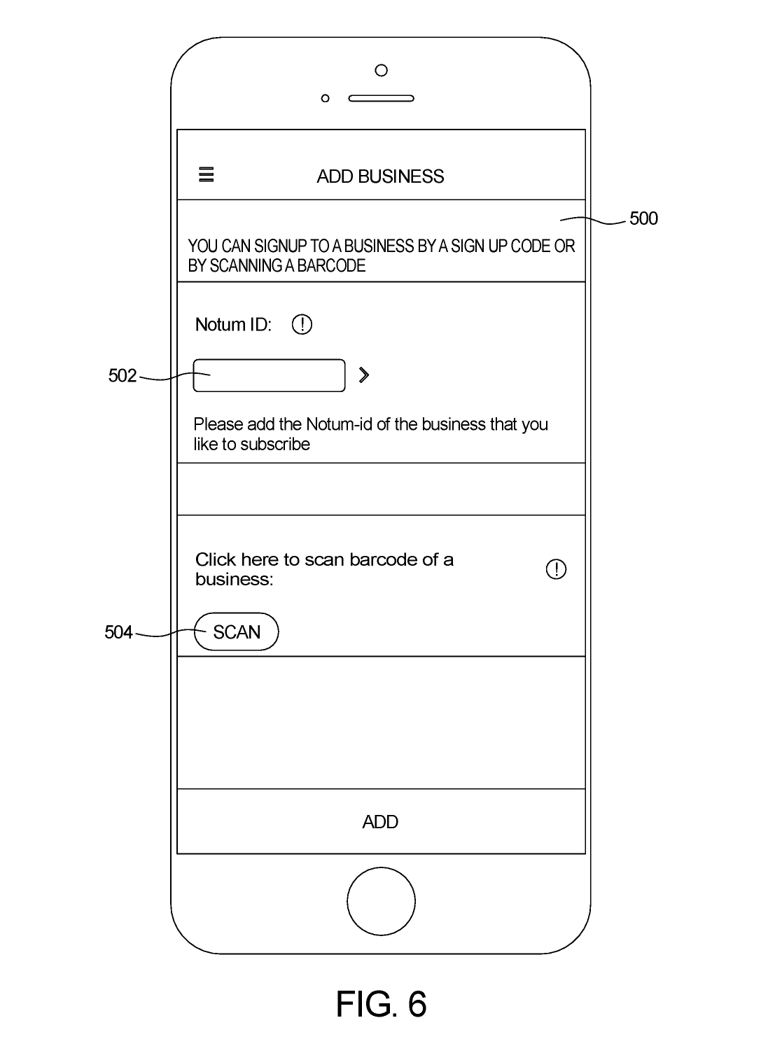

Alternatively, a consumer 104 may be added to a vendor's consumer list through a consumer request. In step 216, a consumer 104 sends a consumer request through the consumer user interface 118 to add a vendor 102 to the consumer's vendor list. In the consumer request user interface 500 shown in FIG. 6, the consumer has the option to enter the identification code in prompt 502 or to scan the vendor's QR code by selecting the touchscreen button 504. As is understood by those of skill in the art, the identification code and the scanning of the QR code may be accomplished through suitable other means. In response to entering a QR or identification code, the centralized message system 100 sends an email or a form to the vendor 102. The system 100 also presents the consumer 104 with the option to register with, send information to, sign into, or update information with the vendor upon scanning or entering the code. At the time of the request, the consumer 104 also selects the level of information to share with the vendor 102 as shown in step 218. In step 220, the vendor 102 decides whether to accept the consumer's request. If the vendor 102 accepts, a confirmed message is sent to the consumer 104 through the centralized message system 100 in step 222. If the vendor 102 declines, a declined message is sent to the consumer 104 through the centralized message system 100 in step 224.

Also shown in FIG. 3, a vendor 102 utilizes the centralized message system 100 to send messages to a subset of consumers 104 on the vendor's consumer list. In step 226, a vendor 102 submits message instructions 107 through the centralized message system 100 to request that a message 103 be sent to a specific subset of consumers 104 on the vendor's consumer list. In the next step 228, the centralized message system 100 sends a message 103 to each consumer 104 within the subset of consumers. In some embodiments, recipients 104 will have the option to mark an alert 103 as marketing material or inappropriate, which will be later reviewed by a system administrator to ensure the quality of alerts sent by the system. The standardized format of the message 103 may be provided in any form as desired. In some embodiments, each message 103 is limited in number of characters, such as, for example, 256 characters. In other embodiments, the centralized message system 100 may preclude the use of marketing materials, images, and/or website addresses in alerts or notifications.

Vendors 102 may utilize the centralized message system 100 to send out scheduling update messages 103 to users. Such communication can be two-way, with the user interfaces 118 allowing consumers 118 to respond to a message 103 if desired. One example of such a situation could be a vendor 102 sending a message 103 stating an appointment will be bumped by an hour and the consumer 104 sending a return notification confirming the new appointment time. In one embodiment, the vendor's message 103 regarding the delayed appointment start time may be triggered automatically by the vendor's scheduling system or artificial intelligence recognizing that the there is a delay in appointment start times.

Vendors 102 may interact with the centralized message system 100 by accessing settings and functionalities which resides on the centralized system server 105. Vendors 102 may access settings stored on the server 105 for messages 103 that they send. If a vendor 102 sends message instructions 107 to the centralized server 105 which requires a response from consumers 104, the centralized server 105 will automatically recognize this requirement and will add this functionality to the messages 103 sent out from the server 105 to consumers 104. If a message 103 sent by a vendor 102 does not require a response, but requires consumers 104 to update their schedules, such automated schedule updating functionality may be included in the message 103. Additionally, any other actions needed in response to a message from a vendor can be input into messages sent out by the server 105 if such functionality is indicated as needed by the vendor's message instructions to the server.

As described in FIG. 3, the message 103 process begins when the centralized server 105 receives message instructions from a vendor 102. Once received, the server 105 analyzes the alert message 103 to determine if any additional functionality is need for the message (e.g., does the recipient need to reply, update their schedule, etc.). The system 100 then performs a query into the subset of consumers 104 from the vendor's consumer list to generate a list of consumers 104 to whom the message 103 should be sent. The subset may be identified in the vendor's message instructions or may be determined by the system 100 based on which consumers 104 are subscribed to receive such messages 103 from the vendor 102. Once the list of consumer recipients 104 is determined for a given message, the message 103 is sent either instantly or at a time specified by the vendor 102 to the consumer user interfaces 118 of the subset of consumers or consumers 104 receiving the message 103. Alternatively, the message 103 may be displayed on the consumer's application's GUI or via a voice prompt, hologram, or virtual reality display.

FIG. 3 further illustrates the ability of the centralized message system 100 to push updates to consumer information to vendors 102. In step 230, a consumer 104 updates consumer information on the centralized message system 100 through its consumer profile on the consumer user interface 118. If the updated consumer information is within the level or category of information shared by the consumer 104 with a particular vendor 102, then the updated consumer information is automatically sent to the vendor 102 in step 232.

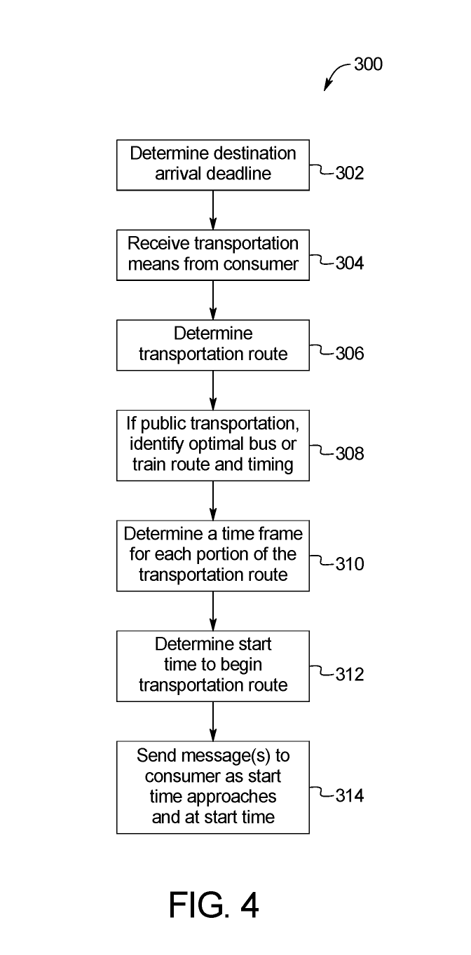

Referring to FIG. 4, the centralized message system 100 may be used to send a message(s) 103 to a consumer 104 indicating what time the consumer 104 should leave for a particular appointment or destination based on location and weather information in an example method 300. At an initial step 302, the centralized message system 100 determines the consumer's destination arrival time. In step 304, the centralized message system 100 receives input from the consumer 104 indicating what type or types of transportation will be used to reach the destination. For example, the consumer 104 may use public transportation, walk, and/or drive to the destination. In step 306, the centralized message system 100 determines the transportation route for the consumer 104, identifying each portion of the route. For example, while a consumer 104 may take the train to reach a doctor's appointment, the transportation route will include a first portion as the consumer 104 walks from the consumer's current location to a first train stop, a second portion for the duration of the train ride from a first train stop to a second train stop, and a third portion as the consumer 104 walks from the second train stop to the doctor's office. If public transportation is used, the centralized message system 100 accesses and receives publicly-available information including current location data of public transportation vehicles and routes in step 308. In step 310, the centralized message system 100 determines a time frame for each portion of the transportation route based on the consumer's location, the final destination, weather information and delays, and consumer's preferred buffer time (i.e., provided in the consumer profile). In the next step 312, the centralized message system 100 determines the start time for the consumer 104 to begin the transportation route. Finally, in step 314, the centralized message system 100 sends one or more messages to the consumer 104 as the start time approaches and at the start time.

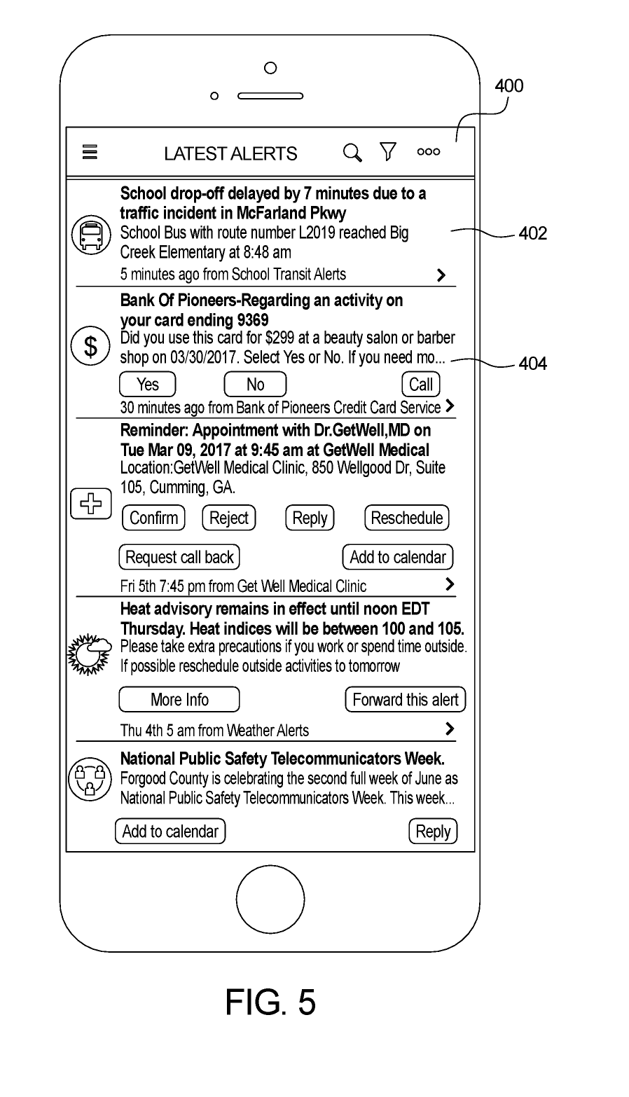

As shown in FIG. 5, messages 103 from different vendors 102 are displayed on a dashboard message user interface 400 of the consumer mobile application. The dashboard message user interface 400 may include messages from a variety of vendors 102 and may be sent by the scheduling tools 112 within the centralized message system 100 to communicate a change in schedule or timing as shown in message 402, directly from a vendor 102 such as messages 404, or any other source such a weather information source in message 406 and a community information source in message 408. Further, each message 103 can be tagged as one of three priority levels as indicated by circular icons to the left hand side of each message. The priority icons may be green (low alert priority), yellow (medium alert priority), and red (high alert priority). The list of messages may be organized according to priority icon, such as by descending priority (i.e., high to low) and/or by the order on which it is received by the system. The priority of the message may be illustrated by an indicator other than color and/or an icon, as desired.

In one embodiment, the consumer 104 may view messages 103 specific to each member of a family. For example, the consumer 104 may identify individuals such as each child, brother, sister, mother, father, etc., and may associate specific vendors 102 with one or more family members. The consumer 104 may also associate specific vendors 102 with other categories such as work, extra curricular activities, or other suitable labels. Still further, within a label, messages 103 may be further categorized according to the source of the message. For example, touchscreen buttons along the top of a user interface allow the consumer 104 to view messages specifically related to certain sources of school alert, such as school transit messages, classroom message, etc.

Some messages 103 sent out by vendors 102 may require a response or other action from consumer 104 in receipt. Links to such actions may be embedded in each message 103 as needed by the server in the form of touchscreen buttons, touchscreen links, and/or voice control prompts through smart voice command devices. In one embodiment, the links are displayed as blue touchscreen buttons within each alert message. When one of these touchscreen buttons is tapped, the consumer 104 may complete the function required such as updating their computerized schedule or sending a confirmation to the vendor 102 that the consumer 104 approves of a rescheduled appointment or any customized action desired by the vendor 102.

The centralized message system 100 may also display messages 103 related to weather that reflect information sent out by local, national, or international weather news sources and the information contained within them can be analyzed by the system to adjust other alerts sent by the system. An example of this could be an alert set up to notify a consumer 104 of when to leave their house to catch the bus. If a winter storm warning is issued by the National Weather Service for the area in which the consumer 104 lives/the bus operates, the centralized message system 100 may modify when the message 103 for the consumer 104 to leave their home to catch the bus is sent out to account for a slower moving bus and the longer walk time for the user to the bus stop. The system 100 may receive “heartbeats” in the form of periodic status updates which will be used as in input to the artificial intelligence or machine learning algorithms to make active adjustment of when alerts are to be sent out by the system as discussed above.

In a further example, a healthcare provider vendor 102 may use the centralized message system 100 to send out appointment reminders for patients 104 and also inform patients 104 of updates, such as when lab results are ready. The centralized message system 100 can insert touchscreen links into messages to allow consumers 104 to carry out any actions needed to be taken in response to the alert (e.g., confirm an appointment scheduling change). Touchscreen links may include links to view lab results, call the doctor's office, and view the physical location of an appointment on a map.

The centralized alert system 100 may also be used to display messages 103 related to community issues. This information may be pulled from any relevant sources (e.g., local news stations, local traffic reports, etc.) and assigned different levels of priority based off pre-defined algorithms stored on the centralized server. This information can be used to adjust the timing and priority of other system messages.

The centralized message system application may run on any suitable computerized device including smart watches, smart kiosks, smart home systems, chat bots, smart digital assistants (such as Amazon Alexa and Google Home), smart car systems, smart televisions, and smart glasses or other forms of virtual reality display. The alerts may be relayed to recipients via any functional means including text, voice prompts, and holograms or other forms of virtual reality display.

The messages 103 provided by the system 100 may be shown on a webpage in addition to, or in place of, the mobile device application. The functionality of the alert displaying webpage may be functionality equivalent to the mobile device application and display alerts separated by topic or category (e.g., school, medical, weather, etc.) on different tabs of the webpage. Alert settings may also be accessed via this webpage by clicking a link to the administration website on the alert displaying webpage. The messages 103 provided by the system may be shown on any other functional means such as voice command devices (such as Amazon Alexa and Window's Cortana) in addition to, or in place of, the mobile device application. The functionality of the alert displaying on a smart television, smart car display, or holographic display may be functionality equivalent to the mobile device application and display alerts separated by topic or category (e.g., school, medical, weather, etc.) on different tabs or sections of the display interface.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A centralized message system comprising:
a controller in communication with one or more vendor user interfaces for each vendor and one or more consumer user interfaces for each consumer;
a database including a plurality of consumers and a plurality of vendors, wherein each consumer has an associated vendor list, wherein each vendor has an associated consumer list; and
a memory coupled to the controller configured to store program instructions executable by the controller, that, when executed, cause the controller to:
receive a request from a first vendor to add a first consumer to a consumer list of the first vendor;
receive one of an acceptance and a declination from the first consumer to the first vendor;
if the first consumer sends the acceptance, receive a first selected category of information from the first consumer for the first vendor;
if the first consumer sends the acceptance, send the first selected category of information to the first vendor;
receive a request from a second consumer to add a second vendor to a vendor list of the second consumer;
receive one of an acceptance and a declination from the second vendor to the second consumer;
if the second vendor sends the acceptance, receive a second selected category of information from the second consumer for the second vendor; and
if the second vendor sends the acceptance, send the second selected category of information to the second vendor.

2. The centralized message system of claim 1, wherein the controller receives a request from a second consumer automatically upon the second user scanning a QR code of the second vendor.

3. The centralized message system of claim 1, wherein the controller further receives an updated information from the consumer user interface and sends the updated information to the vendor user interface of a vendor if the updated information is included in the level of information for the respective vendor.

4. The centralized message system of claim 3, wherein the controller automatically receives the updated information.

5. The centralized message system of claim 4, wherein the information includes one of contact information, home address, and email address.

6. The centralized message system of claim 1, wherein the notification includes an action item.

7. The centralized message system of claim 6, wherein the action item includes one of adding a calendar event, confirming an appointment, and making a telephone call.

8. The centralized message system of claim 1, wherein the controller receives instructions for responding to the action item through voice control prompts.
